(19) United States
(12) Patent Application Publication
(10) Pub. No.: US 2020/0019150 A1
(43) Pub. Date: Jan. 16, 2020

(54) COLLECTION DEVICE, COLLECTION METHOD, PROGRAM, AND COLLECTION SYSTEM

(71) Applicant: MITSUBISHI HITACHI POWER SYSTEMS, LTD., Kanagawa (JP)

(72) Inventors: Masato SHIDA, Kanagawa (JP); Yukihiko INOUE, Tokyo (JP); Kuniaki AOYAMA, Tokyo (JP); Ichiro NAGANO, Kanagawa (JP); Shun NIIZUMA, Kanagawa (JP); Akihisa ENDO, Kanagawa (JP); Takahiro YAMAUCHI, Kanagawa (JP); Tsuyoshi KINOSHITA, Kanagawa (JP); Shinsaku ENDO, Kanagawa (JP)

(21) Appl. No.: 16/464,963

(22) PCT Filed: Sep. 1, 2017
(86) PCT No.: PCT/JP2017/031534

§ 371 Date: May 29, 2019

(30) Foreign Application Priority Data
Dec. 28, 2016 (JP) 2016-257017

(51) Int. Cl. G05B 23/02; H04L 1/00

(52) U.S. Cl. CPC G05B 23/0262; H04L 1/0045

(57) ABSTRACT

A collection device includes a reception unit, a first inspection unit, and a first transmission request unit. The reception unit receives a data unit including operation data indicating an operation state of a plant and a guarantee value for guaranteeing authenticity of the operation data. The first inspection unit inspects the authenticity of the data unit by inspecting a quality of the data unit on the basis of the guarantee value and by inspecting the presence or absence of a loss of the data on the basis of a reception interval of the data unit. The first transmission request unit requests a transmission side of the data unit to retransmit the data unit when inspection results of the first inspection unit indicate no authenticity.

### TECHNICAL FIELD

The present invention relates to a collection device, a collection method, a program, and a collection system.

### BACKGROUND ART

For example, in a plant including a power plant or a chemical plant, a safe and stable operation is desired. In order to prevent occurrence of an abnormality in the plant in advance or discover the occurrence of the abnormality early, remote monitoring for collecting data indicating an operation state from the plant and diagnosing a sign of the abnormality on the basis of the collected data is performed. In such remote monitoring, it is necessary to guarantee the authenticity of the data.

A technology for proving that form data has not been modified after original data is processed and output as the form data when a history of operation data of a power plant or the like is managed is known (see, for example, Patent Literature 1). A technology for generating integrity data that can be verified with a secret key by assigning integrity code to plant data is known (see, for example, Patent Literature 2).

### CITATION LIST

### Patent Literature

[PTL 1] Japanese Unexamined Patent Application Publication No. 2011-028516

[PTL 2] Japanese Unexamined Patent Application Publication No. 2000-194262

### SUMMARY OF INVENTION

### Technical Problem

Data that is collected from a plant for use in a process of diagnosing a sign of an abnormality is diverse. Therefore, there is concern that there is a variation in quality of the collected data. With the data with variations in quality, there is concern that the process of diagnosing a sign of an abnormality cannot be executed. Further, when the quality of the data is not suitable for the process of diagnosing a sign of an abnormality, there is concern that it takes time and effort to prepare appropriate data. Thus, it is desirable to collect data suitable for the process of diagnosing a sign of an abnormality.

The present invention has been made in view of such circumstances, and an object of the present invention is to provide a collection device, a collection method, a program and a collection system for collecting appropriate data.

### Solution to Problem

A collection device of the present invention includes a reception unit that receives a data unit including operation data indicating an operation state of a plant and a guarantee value for guaranteeing authenticity of the operation data; a first inspection unit that inspects the authenticity of the data unit on the basis of the guarantee value; and a first transmission request unit that requests a transmission side of the data unit to retransmit the data unit when inspection results of the first inspection unit indicate no authenticity.

According to this configuration, it is possible to collect appropriate data.

Preferably, the collection device according to the present invention includes a second inspection unit that inspects whether or not the operation data is normal on the basis of whether or not the operation data is a value in a predetermined range; and a second transmission request unit that requests the transmission side of the data unit to transmit a predetermined data unit, wherein the second transmission request unit requests the transmission side of the data unit to transmit a data unit at a time different from that of the data unit including the operation data determined to be abnormal when the second inspection unit determines that the operation data is abnormal. According to this configuration, when the operation data is determined to be abnormal, it is possible to collect appropriate data.

Preferably, the collection device of the present invention includes a complementing unit that complements a value of the operation data included in the data unit, wherein the second inspection unit determines whether or not a process of diagnosing a sign of an abnormality of the plant is executable on the basis of the data unit by complementing the value of the operation data determined to be abnormal with respect to the data unit including the operation data determined to be abnormal in the second inspection unit, and when the second inspection unit determines that the diagnosis process is executable, the complementing unit complements the value of the operation data determined to be abnormal. According to this configuration, when the process of diagnosing a sign of an abnormality of the plant is executable by complementing a value of the operation data determined to be abnormal, it is possible to complement the value of the operation data determined to be abnormal, and to collect appropriate data.

Preferably, the collection device of the present invention includes an acquisition unit that acquires diagnosis results of a process of diagnosing a sign of an abnormality of the plant using the data unit; and a third transmission request unit that requests the transmission side of the data unit to transmit the data unit so that a reception interval in the reception unit is changed, wherein when the diagnosis results acquired by the acquisition unit indicates that there is a sign of an abnormality, the third transmission request unit requests the transmission side of the data unit to transmit the data unit so that the reception interval in the reception unit is changed. According to this configuration, when the diagnosis results indicate that there is a sign of an abnormality, it is possible to collect appropriate data.

Preferably, the collection device of the present invention includes an acquisition unit that acquires diagnosis results of a process of diagnosing a sign of an abnormality of the plant using the data unit; and a fourth transmission request unit that requests the transmission side of the data unit to change items of the operation data to be included and transmit the data unit, wherein when the diagnosis results acquired by the acquisition unit indicates that there is a sign of an abnormality, the fourth transmission request unit requests the transmission side of the data unit to change the items of the operation data to be included and transmit the data unit. According to this configuration, when the diagnosis results indicate that there is a sign of an abnormality, it is possible to collect appropriate data.

Preferably, in the collection device of the present invention, when the diagnosis results acquired by the acquisition unit indicates that there is a sign of an abnormality, the third transmission request unit requests the transmission side of the data unit to shorten the reception interval in the reception unit and transmit the data unit. According to this configuration, when the diagnosis results indicate that there is a sign of an abnormality, it is possible to collect appropriate data.

Preferably, in the collection device of the present invention, when the diagnosis results acquired by the acquisition unit indicates that there is a sign of an abnormality, the third transmission request unit requests the transmission side of the data unit to shift the reception interval in the reception unit and transmit the data unit. According to this configuration, when the diagnosis results indicate that there is a sign of an abnormality, it is possible to collect appropriate data.

A collection method of the present invention includes a reception step of receiving a data unit including operation data indicating an operation state of a plant and a guarantee value for guaranteeing authenticity of the operation data; an inspection step of inspecting the authenticity of the data unit on the basis of the guarantee value; and a transmission request step of requesting a transmission side of the data unit to retransmit the data unit when inspection results in the inspection step indicate no authenticity.

According to this method, it is possible to collect appropriate data.

A program according to the present invention causes a computer to execute: a reception step of receiving a data unit including operation data indicating an operation state of a plant and a guarantee value for guaranteeing authenticity of the operation data; an inspection step of inspecting the authenticity of the data unit on the basis of the guarantee value; and a transmission request step of requesting a transmission side of the data unit to retransmit the data unit when inspection results in the inspection step indicate no authenticity.

According to this program, it is possible to collect appropriate data.

A collection system of the present invention includes a collection device including a reception unit that receives a data unit including operation data indicating an operation state of a plant and a guarantee value for guaranteeing authenticity of the operation data, a first inspection unit that inspects the authenticity of the data unit on the basis of the guarantee value, and a first transmission request unit that requests a transmission side of the data unit to retransmit the data unit when inspection results of the first inspection unit indicate no authenticity; and a transmission device including a transmission unit that transmits the data unit to the collection device.

According to this configuration, it is possible to collect appropriate data.

### Advantageous Effects of Invention

According to the present invention, it is possible to realize a collection device, a collection method, a program, and a collection system for collecting appropriate data.

### BRIEF DESCRIPTION OF DRAWINGS

FIG. 1 is a block diagram illustrating an example of a collection system according to an embodiment of the present invention.

FIG. 2 is a block diagram of a diagnosis device.

FIG. 3 is a block diagram of a management device.

FIG. 4 is a block diagram of a transmission device.

FIG. 5A is a schematic diagram illustrating an example of data that is acquired by the transmission device.

FIG. 5B is a schematic diagram illustrating another example of the data that is acquired by the transmission device.

FIG. 6 is a schematic diagram illustrating an example of an operation data unit.

FIG. 7 is a block diagram of a collection device according to an embodiment of the present invention.

FIG. 8 is a schematic diagram illustrating another example of the operation data unit.

FIG. 9 is a schematic diagram illustrating another example of the operation data unit.

FIG. 10 is a schematic diagram illustrating another example of the operation data unit.

FIG. 11 is a flowchart illustrating an overview of a collection method in the collection device according to the embodiment of the present invention.

FIG. 12 is a flowchart illustrating an overview of the collection method in the collection device according to the embodiment of the present invention.

FIG. 13 is a schematic diagram illustrating data exchange between the collection device, the transmission device, and the management device according to an embodiment of the present invention.

### DESCRIPTION OF EMBODIMENTS

Hereinafter, embodiments of the present invention will be described in detail with reference to the accompanying drawings. The present invention is not limited to the following embodiments, and can be implemented with appropriate modifications.

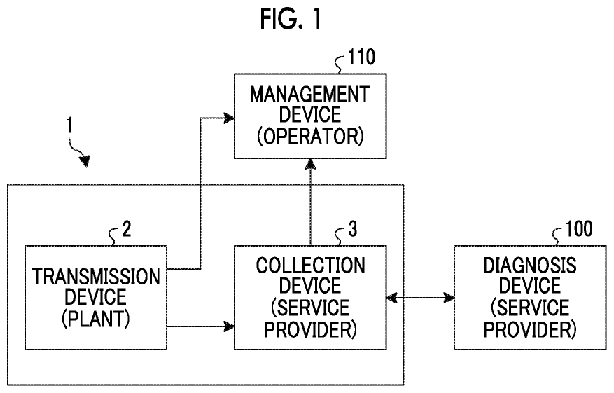

FIG. 1 is a block diagram illustrating an example of a collection system according to an embodiment of the present invention. A collection system 1 collects operation data for use in a process of diagnosing a sign of an abnormality of a plant in a diagnosis device 100. The collection system 1 can transmit and receive data to and from the diagnosis device 100 and a management device 110.

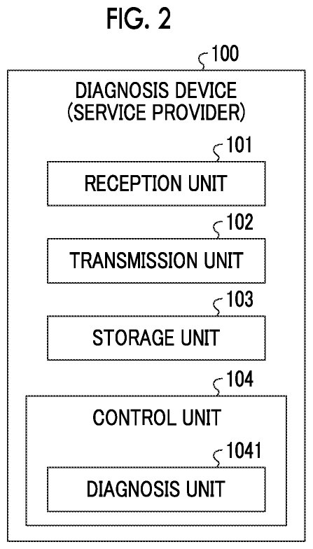

The diagnosis device 100 will be described with reference to FIG. 2. FIG. 2 is a block diagram of the diagnosis device. The diagnosis device 100 is installed within a base of a service provider that remotely monitors the plant. The diagnosis device 100 diagnoses the presence or absence of a sign of an abnormality in the plant on the basis of an operation data unit DU to be described below, which is received from the collection device 3. The diagnosis device 100 transmits diagnosis results to the collection device 3. The diagnosis device 100 includes a reception unit 101, a transmission unit 102, a storage unit 103, and a control unit 104.

The reception unit 101 is capable of receiving data from the collection device 3. The reception unit 101 receives the operation data unit DU from the collection device 3.

The transmission unit 102 is capable of transmitting data to the collection device 3. The transmission unit 102 transmits the diagnosis results to the collection device 3.

The storage unit 103 stores various programs and various databases that are used to execute information processing in the control unit 104. The storage unit 103 stores the received operation data unit DU. The storage unit 103 stores diagnosis results.

The control unit 104 includes a memory and a CPU. The control unit 104 may be realized by dedicated hardware or may be a control unit of which a function is realized by loading a program for realizing the function of the control unit 104 into the memory and executing the program. The control unit 104 has a diagnosis unit 1041.

The diagnosis unit 1041 executes a diagnosis process of diagnosing the presence or absence of a sign of an abnormality in the plant on the basis of the received operation data unit DU.

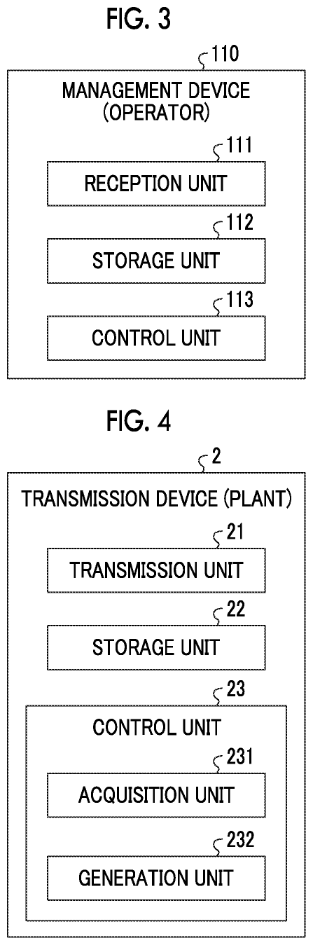

The management device 110 will be described with reference to FIG. 3. FIG. 3 is a block diagram of the management device. The management device 110 is installed within a base of an operator of the plant. The management device 110 manages the operation data unit DU which is data indicating an operation state of the plant. The management device 110 includes a reception unit 111, a storage unit 112, and a control unit 113.

The reception unit 111 can receive data from the transmission device 2. The reception unit 111 receives the operation data unit DU transmitted by the transmission device 2.

The storage unit 112 stores various programs and various databases that are used to execute information processing in the control unit 113. The storage unit 112 stores the received operation data unit DU.

Referring back to FIG. 1, the collection system 1 includes a transmission device 2 and a collection device 3.

The transmission device 2 will be described with reference to FIG. 4. FIG. 4 is a block diagram of the transmission device. The transmission device 2 is installed in the plant. The transmission device 2 acquires operation data indicating an operation state of a plant output from a device or a sensor, and transmits the operation data to the collection device 3 and the management device 110. More specifically, the transmission device 2 transmits operation data unit DU including the acquired operation data and a hash value for guaranteeing the authenticity of the operation data to the collection device 3 and the management device 110. The transmission device 2 includes a transmission unit 21, a storage unit 22, and a control unit 23. The hash value is an example of a guarantee value for guaranteeing the authenticity of the operation data.

The transmission unit 21 is capable of transmitting data to the collection device 3 and the management device 110. The transmission unit 21 transmits the operation data unit DU to the collection device 3 and the management device 110 at desired time intervals. For example, the transmission unit 21 transmits the operation data unit DU to the collection device 3 and the management device 110 at sampling intervals.

The operation data unit DU includes at least one piece of operation data and hash values. The operation data is data acquired by a sensor attached to a component of a plant device. In the embodiment, the operation data includes a plurality of pieces of data from data A acquired by a sensor A to data ZA acquired by a sensor ZA. The hash value is uniquely set for each operation data unit DU. For example, the hash value is calculated using a hash function on the basis of the operation data included in the operation data unit DU.

The sampling interval is a time interval Δt at which the operation data unit DU is transmitted to the collection device 3 and the management device 110.

The storage unit 22 stores various programs and various databases that are used to execute information processing in the control unit 23. The storage unit 22 stores the operation data and the operation data unit DU.

The control unit 23 includes a memory and a central processing unit (CPU). The control unit 23 may be realized by dedicated hardware or may be a control unit of which a function is realized by loading a program for realizing the function of the control unit 23 into the memory and executing the program. The control unit 23 includes an acquisition unit 231 and a generation unit 232.

The acquisition unit 231 acquires the operation data acquired by the sensor attached to the component of the plant device. The acquisition unit 231 acquires data at least at the same time intervals as the sampling intervals. The acquisition unit 231 stores the acquired data in the storage unit 22.

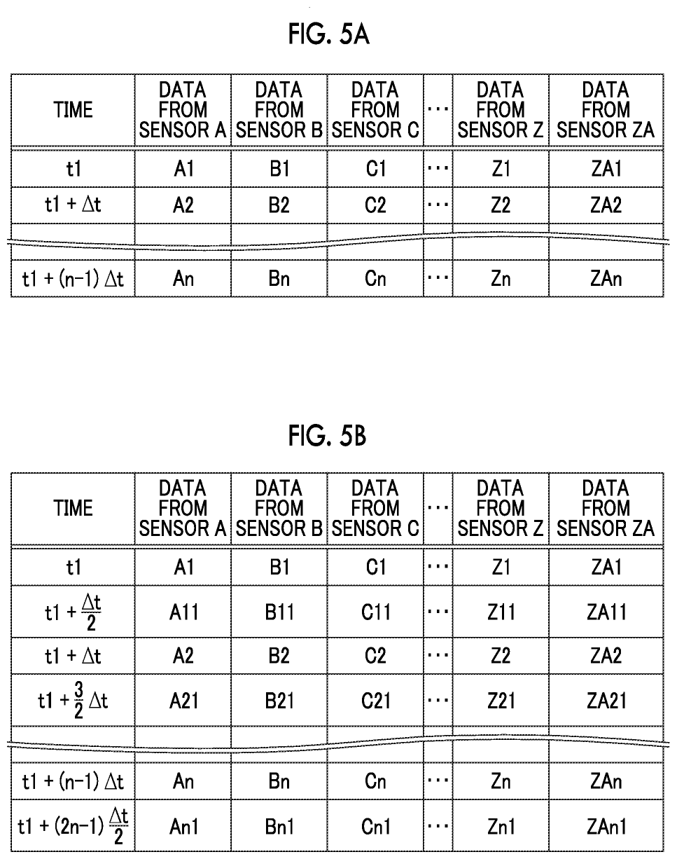

The data acquired by the acquisition unit 231 will be described with reference to FIGS. 5A and 5B. FIG. 5A is a schematic diagram illustrating an example of the data acquired by the transmission device. FIG. 5B is a schematic diagram illustrating another example of the data acquired by the transmission device. In the embodiment, it is assumed that the operation data acquired by sensors from sensor A to sensor ZA is received at sampling intervals Δt. For example, as illustrated in FIG. 5A, at time t1, data A1 is acquired from sensor A, data B1 is acquired from sensor B, data C1 is acquired from sensor C, data Z1 is acquired from sensor Z, and data ZA1 is acquired from sensor ZA. At time t1+Δt, data A2 is acquired from sensor A, data B2 is acquired from sensor B, data C2 is acquired from sensor C, data Z2 is acquired from sensor Z, and data ZA2 is acquired from sensor ZA. At time t1+(n−1)Δt, data An is acquired from sensor A, data Bn is acquired from sensor B, data Cn is acquired from sensor C, data Zn is acquired from sensor Z, and data ZAn is acquired from sensor ZA. n is a natural number.

Alternatively, the operation data acquired by the sensors from sensor A to sensor ZA may be received at time interval shorter than the sampling interval Δt. In this case, for example, as illustrated in FIG. 5B, at time t1+Δt/2, data A11 is acquired from sensor A, data B11 is acquired from sensor B, data C11 is acquired from sensor C, data Z11 is acquired from sensor Z, and data ZA11 is acquired from sensor ZA, in addition to the operation data at the sampling interval Δt. At time t1+(3/2)Δt, data A21 is acquired from sensor A, data B21 is acquired from sensor B, data C21 is acquired from sensor C, data Z21 is acquired from sensor Z, and data ZA21 is acquired from sensor ZA. At time t1+(2n−1) (Δt/2), data An1 is acquired from sensor A, data Bn1 is acquired from sensor B, data Cn lis acquired from sensor C, data Zn1 is acquired from sensor Z, and data ZAn1 is acquired from sensor ZA.

The generation unit 232 generates the operation data unit DU in which the operation data and the hash value are combined. The generation unit 232 may generate the operation data unit DU including all the pieces of operation data acquired by the acquisition unit 231 or may generate the operation data unit DU including some of the acquired pieces of operation data. The generation unit 232 stores the generated operation data unit DU in the storage unit 22.

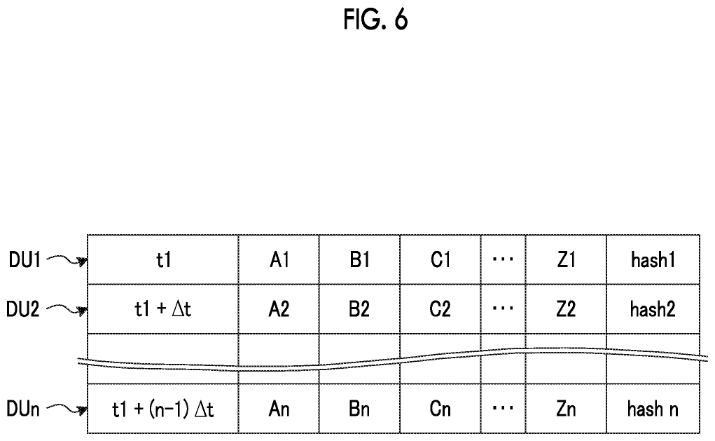

The operation data unit DU generated by the generation unit 232 will be described with reference to FIG. 6. FIG. 6 is a schematic diagram illustrating an example of the operation data unit. In the embodiment, the generation unit 232 generates the operation data unit DU including the operation data acquired by the sensors from sensor A to the sensor Z at sampling intervals. For example, the generation unit 232 generates an operation data unit DU1 including data A1 acquired from sensor A, data B1 acquired from the sensor B, data C1 acquired from the sensor C, and data Z1 acquired from the sensor Z as the operation data, and including a hash value hash1 generated from the operation data. The generation unit 232 generates an operation data unit DU2 including data A2 acquired from sensor A, data B2 acquired from the sensor B, data C2 acquired from the sensor C, and data Z2 acquired from the sensor Z as the operation data, and including a hash value hash2 generated from the operation data. The generation unit 232 generates an operation data unit DUn including data An acquired from sensor A, data Bn acquired from the sensor B, data Cn acquired from the sensor C, and data Zn acquired from the sensor Z as the operation data, and including a hash value hashn generated from the operation data. In the following description, each of the operation data units will be described as an operation data unit DU when the operation data units are not distinguished from each other.

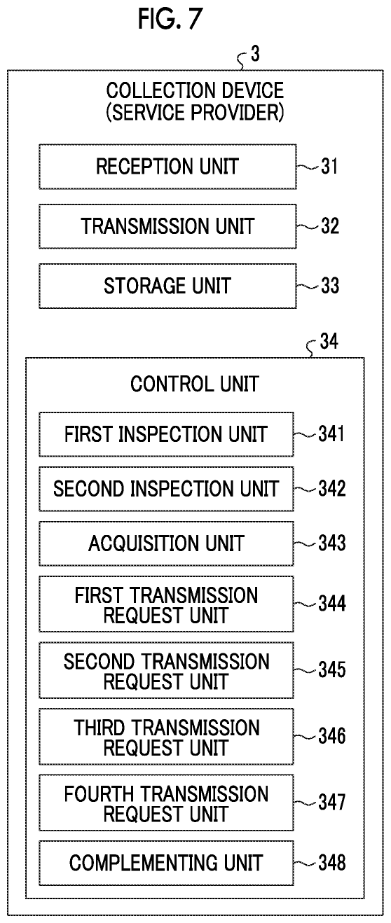

The collection device 3 will be described with reference to FIG. 7. FIG. 7 is a block diagram of the collection device according to an embodiment of the present invention. The collection device 3 is installed within a base of a service provider that remotely monitors the plant. The collection device 3 collects an operation data unit DU which is data indicating an operation state of the plant. The collection device 3 outputs the operation data unit DU to the diagnosis device 100. The collection device 3 includes a reception unit 31, a transmission unit 32, a storage unit 33, and a control unit 34.

The reception unit 31 can receive data from the transmission device 2. The reception unit 31 receives the operation data unit DU transmitted by the transmission device 2. The reception unit 31 may receive all operation data units DU generated from the operation data acquired by the acquisition unit 231 of the transmission device 2 or may receive some of the generated operation data units DU.

The transmission unit 32 can transmit data to the diagnosis device 100 and the management device 110. The transmission unit 32 transmits the operation data unit DU to the diagnosis device 100. The transmission unit 32 transmits the diagnosis results acquired from the diagnosis device 100 to the management device 110.

The storage unit 33 stores various programs and various databases that are used to execute information processing in the control unit 34. The storage unit 33 stores the received operation data unit DU. The storage unit 33 stores a data range (a predetermined range) that data can be taken, for each data item included in the operation data unit DU.

The control unit 34 includes a memory and a CPU. The control unit 34 may be realized by dedicated hardware or may be a control unit of which a function is realized by loading a program for realizing the function of the control unit 34 into the memory and executing the program. The control unit 34 includes a first inspection unit 341, a second inspection unit 342, an acquisition unit 343, a first transmission request unit 344, a second transmission request unit 345, a third transmission request unit 346, a fourth transmission request unit 347, and a complementing unit 348.

The first inspection unit 341 inspects whether or not the data is authentic on the basis of the quality of the received operation data unit DU and the presence or absence of a loss of the data of the received operation data unit DU. First, the first inspection unit 341 inspects the quality of the received operation data unit DU. The first inspection unit 341 compares a hash value of the received operation data unit DU (hereinafter referred to as a “received hash value”) with a hash value of the operation data unit DU (hereinafter referred to as a “transmitted hash value”) stored in the storage unit 22 of the transmission device 2. When the received hash value matches the transmitted hash value, the first inspection unit 341 determines that the quality is high. For example, when the operation data unit DU is correctly transmitted and received and there is no falsification of the data, the quality is determined to be high. When the received hash value does not match the transmitted hash value, the first inspection unit 341 determines that the quality is low. For example, when the operation data unit DU is not correctly transmitted and received due to a communication error or the data of the operation data unit DU has been falsified, the received hash value does not match the transmitted hash value, and the quality is determined to be low.

Further, the first inspection unit 341 inspects whether or not there is a loss of the data of the received operation data unit DU. The first inspection unit 341 sorts the received operation data units DU at a reception time. When a reception interval of the sorted operation data units DU is longer than the sampling interval, the first inspection unit 341 determines that there is a loss of data. For example, when the operation data unit DU has not been transmitted or received due to a communication error, it is determined that the reception interval of the sorted operation data unit DU is longer than the sampling interval and there is a loss of data. When the reception interval of the received operation data unit DU matches the sampling interval, the first inspection unit 341 determines that there is no loss of the data.

The first inspection unit 341 determines that the data is authentic when the quality of the data is high and there is no loss of the data.

The second inspection unit 342 inspects whether or not the data of the received operation data unit DU is normal. The second inspection unit 342 inspects whether or not each piece of operation data included in the received operation data unit DU satisfies a data range of the operation data. When the operation data satisfies the data range, the second inspection unit 342 determines that the operation data is normal. When the operation data does not satisfy the data range, the second inspection unit 342 determines that the operation data is abnormal. For example, when a sensor fails, a value out of the data range is acquired or a value is not acquired, and the operation data is determined to be abnormal.

Further, when the second inspection unit 342 determines that the operation data is abnormal, the diagnosis device 100 determines whether or not execution of the process of diagnosing a sign of an abnormality can be performed using the operation data unit DU. For example, when the operation data is slightly out of the data range or when the operation data can be complemented with the average value or the like, it is determined that diagnosis is executable. For example, when the operation data is greatly out of the data range or when the operation data cannot be complemented, it is determined that diagnosis is no executable.

The acquisition unit 343 acquires the diagnosis results of the process of diagnosing a sign of an abnormality from the diagnosis device 100. The acquisition unit 343 stores the acquired diagnosis results in the storage unit 33.

When it is determined that the data is not authentic, the first transmission request unit 344 requests the transmission device 2 to retransmit the operation data unit DU. For example, when a cause of the determination that the data is not authentic is that the operation data unit DU has not been correctly transmitted or received due to a communication error or that the data of the operation data unit DU has been falsified, the retransmitted operation data unit DU is highly likely to be determined to be authentic.

When there is an abnormality in the data and the diagnosis in the diagnosis device 100 is determined to be impossible, the second transmission request unit 345 requests the transmission device 2 to transmit the operation data unit DU at a time different from that of the operation data unit DU of which the data has been determined to be abnormal. When there is an abnormality in the data and the diagnosis in the diagnosis device 100 is determined to be impossible, the second transmission request unit 345 requests the transmission device 2 to transmit the operation data unit DU at times before and after the operation data unit DU of which the data has been determined to be abnormal. When there is an abnormality in the data and the diagnosis in the diagnosis device 100 is determined to be impossible, the second transmission request unit 345 requests the transmission device 2 to transmit the operation data unit DU that is generated on the basis of the operation data newly acquired by the transmission device 2.

Description will be given in more detail with reference to FIGS. 5A and 6. It is assumed that the collection device 3 has received the operation data unit DU as illustrated in FIG. 6. When the data of the operation data unit DU1 at time t1 is determined to be abnormal, the second transmission request unit 345 makes a request for transmission of the operation data unit DU11 at time t1+Δt/2 after time t1. When an abnormal value is included in only the operation data unit DU1, the data of the operation data unit DU11 is highly likely to be determined not to be abnormal.

The third transmission request unit 346 makes a request for transmission of the operation data unit DU of which the sampling interval has been changed, on the basis of the diagnosis results acquired by the acquisition unit 343. The third transmission request unit 346 may make a request for transmission of the operation data unit DU generated by changing the sampling interval on the basis of the operation data newly acquired by the transmission device 2.

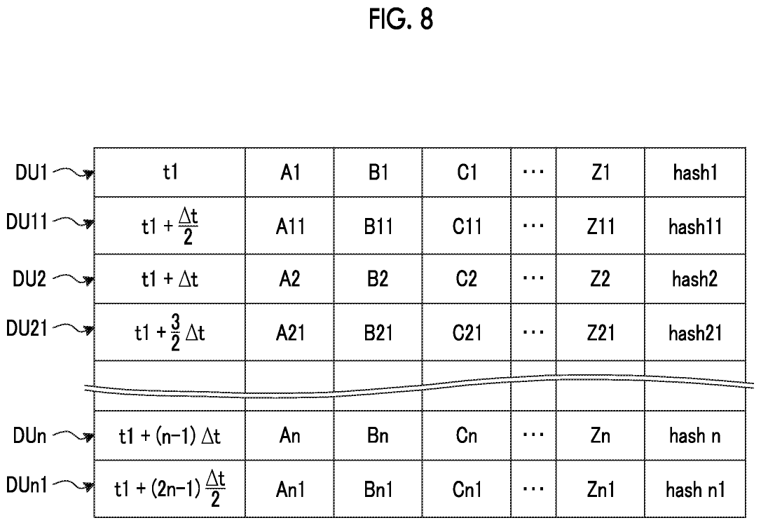

For example, when the third transmission request unit 346 determines that a diagnosis process using more operation data units DU is required in order to accurately specify a failure timing on the basis of the diagnosis results, the third transmission request unit 346 may make a request for transmission of the operation data unit DU of which the sampling interval has been shortened. This will be described in more detail with reference to FIG. 8. FIG. 8 is a schematic diagram illustrating another example of the operation data unit. For example, the third transmission request unit 346 may make a request for transmission of the operation data unit DU at sampling intervals Δt/2 by shortening the sampling interval. Accordingly, more operation data units DU are obtained.

The third transmission request unit 346 makes a request for transmission of the operation data unit DU of which a cycle of the sampling interval has been shifted, on the basis of the diagnosis results acquired by the acquisition unit 343. The third transmission request unit 346 may make a request for transmission of the operation data unit DU generated by shifting the cycle of the sampling interval, on the basis of the operation data newly acquired by the transmission device 2.

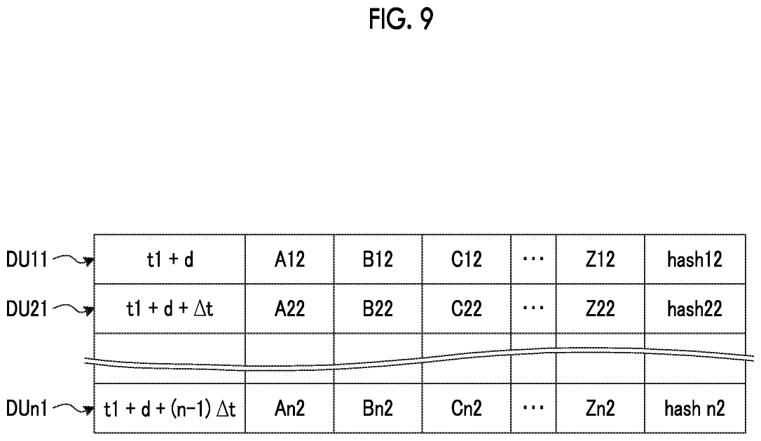

For example, when the third transmission request unit 346 determines that a diagnosis process using the operation data unit DU of which the cycle of the sampling interval has been shifted is required on the basis of the diagnosis results, the third transmission request unit 346 may make a request for transmission of the operation data unit DU of which the cycle of the sampling interval has been shifted instead of changing the sampling interval. This will be described in more detail with reference to FIG. 9. FIG. 9 is a schematic diagram illustrating another example of the operation data unit. The third transmission request unit 346 may make a request for transmission of the operation data unit DUn2 at a time t1+d+(n−1)Δt in place of the operation data unit DUn at a time t1+(n−1)Δt at sampling intervals Δt. Accordingly, the number of operation data units DU to be received is not changed, and the operation data unit DU of which the cycle of the sampling interval has been shifted can be obtained.

The fourth transmission request unit 347 requests the transmission device 2 to transmit the operation data unit DU of which the data item has been changed, on the basis of the diagnosis results acquired by the acquisition unit 343. In order to specify a cause of the abnormality, the operation data unit DU of which the data item has been changed so that data from the sensor which is not acquired at an ordinary time is included is acquired. The fourth transmission request unit 347 may make a request for transmission of the operation data unit DU generated by changing the data item of the operation data unit DU, on the basis of the operation data newly acquired by the transmission device 2.

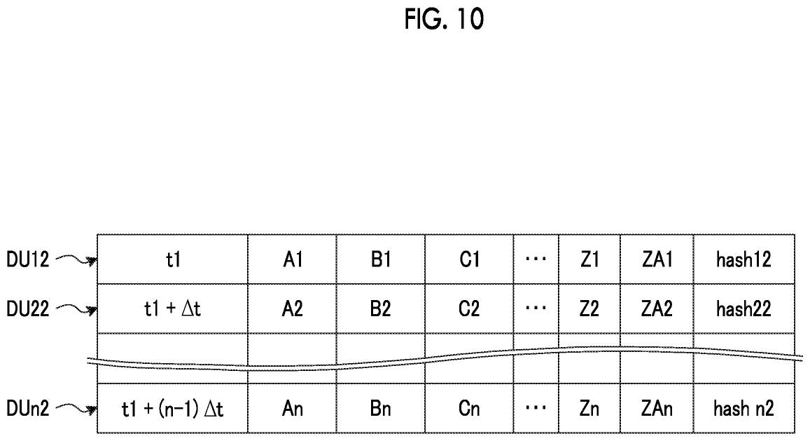

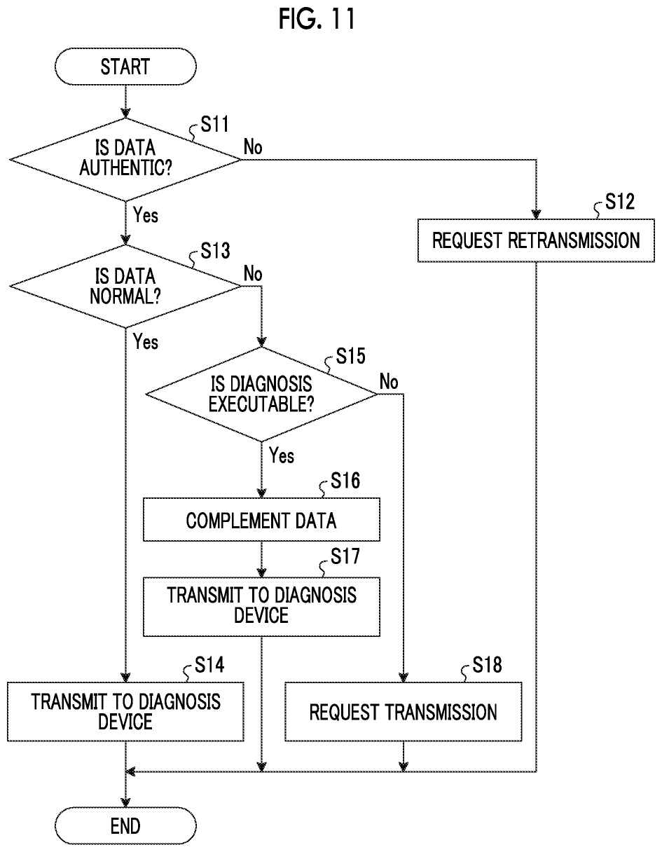

This will be described in more detail with reference to FIG. 10. FIG. 10 is a schematic diagram illustrating another example of the operation data unit. The fourth transmission request unit 347 requests the transmission device 2 to transmit the operation data unit DU to which the data item of the data ZA from sensor ZA has been added.

When the data is abnormal and it is determined that the diagnosis in the diagnosis device 100 is possible the complementing unit 348, for example, complements each piece of operation data of the operation data unit DU determined to be abnormal with an average value of each piece of operation data of the operation data unit DU. The complementing unit 348 may complement all pieces of the operation data of the operation data unit DU with the average value or may complement only the operation data of which the data has been determined to be abnormal with the average value.

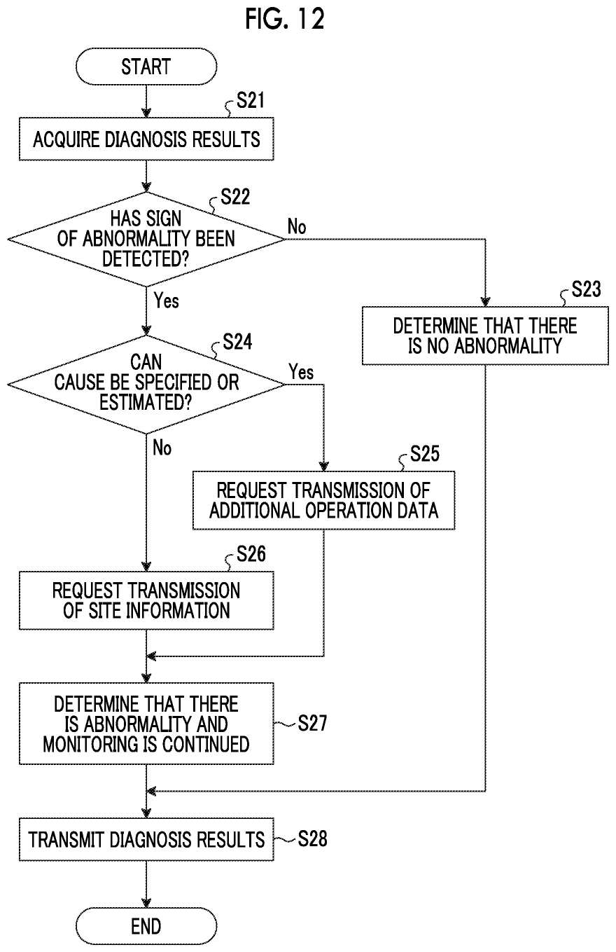

Next, a collection method using the collection device 3 will be described with reference to FIGS. 11 and 12. FIG. 11 is a flowchart illustrating an overview of the collection method in the collection device according to the embodiment of the present invention. FIG. 12 is a flowchart illustrating an overview of a collection method in the collection device according to the embodiment of the present invention.

While the collection device 3 is activated, the control unit 34 is in a state in which the control unit 34 can always receive, with the reception unit 31, the operation data unit DU transmitted by the transmission device 2. When the control unit 34 receives the operation data unit DU with the reception unit 31, the control unit 34 executes a process of the flowchart illustrated in FIG. 11.

First, in the control unit 34, the first inspection unit 341 inspects the quality of the received operation data unit DU (step S11). In the control unit 34, the first inspection unit 341 inspects whether or not there is a loss of the data of the received operation data unit DU. When the first inspection unit 341 determines that the quality is high and there is no loss of the data, the control unit 34 determines that the data is authentic (Yes in step S11). The high quality means that the operation data unit DU is correctly transmitted and received and there is no falsification of the data. When the control unit 34 determines that the data is authentic, the control unit 34 proceeds to step S13. When the first inspection unit 341 determines that the quality is low or there is a loss of the data, the control unit 34 determines that the data is not authentic (No in step S11). The low quality means that the operation data unit DU is not correctly transmitted or received due to a communication error, or the data of the operation data unit DU has been falsified. When the control unit 34 determines that the data is not authentic, the control unit 34 proceeds to step S12.

In the control unit 34, the first transmission request unit 344 requests the transmission device 2 to retransmit the operation data unit DU (step S12). The control unit 34 ends the process of this flowchart. When the reception unit 31 receives the operation data unit DU based on the retransmission request in step S12, the process is executed from step S11 for the received operation data unit DU.

In the control unit 34, the second inspection unit 342 inspects whether or not data of the received operation data unit DU is normal (step S13). When the first inspection unit 341 determines that the operation data satisfies the data range, the control unit 34 determines that the operation data is normal (Yes in step S13). When the control unit 34 determines that the operation data is normal, the process proceeds to step S14. When the first inspection unit 341 determines that the operation data does not satisfy the data range, the control unit 34 determines that the operation data is not normal (No in step S13). When the control unit 34 determines that the operation data is not normal, the process proceeds to step S15.

The control unit 34 transmits the operation data unit DU to the diagnosis device 100 using the transmission unit 32 (step S14). Through this process, it is guaranteed that the data of the operation data unit DU transmitted to the diagnosis device 100 is authentic and normal. The control unit 34 ends the process of this flowchart.

In the control unit 34, the second inspection unit 342 determines whether or not a diagnosis process is executable using the operation data unit DU in the diagnosis device 100 (step S15). The “diagnosis process is executable” refers to a state in which sufficient data has been collected to perform the abnormality diagnosis. When the second inspection unit 342 determines that the diagnosis can be performed (Yes in step S15), the control unit 34 proceeds to step S16. When the second inspection unit 342 determines that the diagnosis cannot be performed (No in step S15), the control unit 34 proceeds to step S18.

The control unit 34 complements the data (step S16). For example, in the control unit 34, the complementing unit 348 complements the operation data unit DU with an average value. The control unit 34 proceeds to step S17.

The control unit 34 transmits the complemented operation data unit DU to the diagnosis device 100 using the transmission unit 32 (step S17). The control unit 34 ends the process of this flowchart.

In the control unit 34, the second transmission request unit 345 requests the transmission device 2 to transmit the operation data unit DU before and after the operation data unit DU of which the data is determined to be abnormal (step S18). The control unit 34 ends the process of this flowchart. When the reception unit 31 receives the operation data unit DU based on the transmission request in step S18, the process is executed from step S11 for the received operation data unit DU.

Thus, the operation data unit DU suitable for the diagnosis process in the diagnosis device 100 is collected. In the diagnosis device 100, a diagnosis process is executed using the operation data unit DU. The diagnosis device 100 transmits the diagnosis results to the collection device 3.

When the collection device 3 is activated, the control unit 34 executes a process of the flowchart illustrated in FIG. 12 when the control unit 34 receives the diagnosis results from the diagnosis device 100. The control unit 34 is in a state in which the acquisition unit 343 can always acquire the diagnosis results transmitted from the diagnosis device 100. In the control unit 34, the acquisition unit 343 acquires the diagnosis results from the diagnosis device 100 (step S21). The control unit 34 proceeds to step S22.

The control unit 34 determines whether or not a sign of an abnormality has been detected (step S22). When the diagnosis results indicate that the sign of the abnormality has been detected (Yes in step S22), the control unit 34 proceeds to step S24. When the diagnosis results indicate that the sign of the abnormality has not been detected (No in step S22), the control unit 34 proceeds to step S23.

The control unit 34 determines that there is no abnormality (step S23). The control unit 34 proceeds to step S28.

The control unit 34 determines whether or not a cause can be specified or estimated (step S24). More specifically, the control unit 34 determines whether or not the cause of the sign of the abnormality can be specified or estimated. For example, when a portion that causes the sign of the abnormality is specified or estimated, the control unit 34 determines that the cause can be specified or estimated. When the cause can be specified or estimated (Yes in step S24), the control unit proceeds to step S25. When the cause cannot be specified or estimated (No in step S24), the control unit 34 proceeds to step S26.

In the control unit 34, the third transmission request unit 346 requests the transmission device 2 to transmit the operation data unit DU so that data related to a portion that causes the sign of the abnormality is added (step S25). For example, the control unit 34 makes a request for transmission of the operation data unit DU at the changed sampling intervals. For example, in the control unit 34, the third transmission request unit 346 makes a request for transmission of the operation data unit DU in the changed data item. The control unit 34 proceeds to step S27. When the reception unit 31 receives the operation data unit DU based on the transmission request in step S25, the process is executed from step S11 for the received operation data unit DU.

In the control unit 34, the fourth transmission request unit 347 requests the transmission device 2 to transmit additional data such as site information necessary for specifying the cause of the sign of the abnormality in addition to the operation data unit DU (step S26). Examples of the site information may include presence or absence of a sensor failure, and information on emergency stop of the plant. The control unit 34 proceeds to step S27. When the reception unit 31 receives the operation data unit DU based on the transmission request in step S26, the process is executed from step S11 for the received operation data unit DU.

The control unit 34 determines that there is an abnormality and monitoring is continued (step S27). The control unit 34 proceeds to step S28.

In the control unit 34, the transmission unit 32 transmits the diagnosis results acquired from the diagnosis device 100 to the management device 110 (step S28).

Thus, in the collection system 1, the operation data units DU for use in diagnosis in the diagnosis device 100 are appropriately collected.

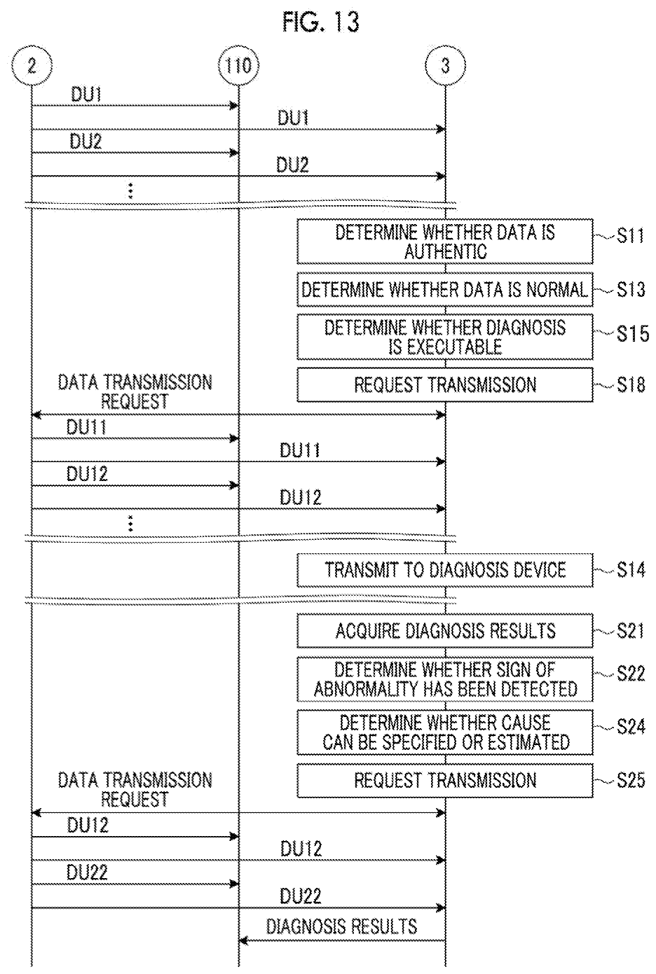

Next, data exchange in the collection system 1 will be described with reference to FIG. 13. FIG. 13 is a schematic diagram illustrating data exchange between the collection device, the transmission device, and the management device according to the embodiment of the present invention.

The transmission device 2 transmits the operation data unit DU to the collection device 3 and the management device 110.

The collection device 3 executes a process of the flowchart illustrated in FIG. 11 on the basis of the received operation data unit DU. In the collection device 3, the control unit 34 inspects the quality of the received operation data unit DU (step S11). When the quality is determined to be high, the control unit 34 inspects whether or not the data of the received operation data unit DU is normal (step S13). When the control unit 34 determines that the data is normal, the control unit 34 determines whether or not sufficient data for performing abnormality diagnosis using the operation data unit DU in the diagnosis device 100 is collected (step S15). When the control unit 34 determines that sufficient data is not collected, the control unit 34 requests the transmission device 2 to transmit the operation data unit DU before and after the operation data unit DU of which the data is determined to be abnormal (step S18).

In the transmission device 2, the operation data unit DU corresponding to the transmission request is transmitted to the collection device 3 and the management device 110 on the basis of the transmission request for the operation data unit DU from the collection device 3.

In the management device 110, the received operation data unit DU is stored in the storage device.

In the collection device 3, when a process of the flowchart illustrated in FIG. 11 is executed on the basis of the received operation data unit DU and when it is determined that the data is normal in step S13, the operation data unit DU is transmitted to the diagnosis device 100.

In the diagnosis device 100, abnormality diagnosis is executed on the basis of operation data unit DU.

When the diagnosis results are received from the diagnosis device 100, a process of the flowchart illustrated in FIG. 12 is executed in the collection device 3, and the diagnosis results are acquired from the diagnosis device 100 (step S21).

In the collection device 3, the control unit 34 determines whether or not a sign of an abnormality has been detected (step S22). When the control unit 34 determines that the sign of the abnormality has been detected, the control unit 34 determines whether or not a cause can be specified or estimated (step S24). When the control unit 34 determines that the cause can be specified or estimated, the control unit 34 requests the transmission device 2 to transmit the operation data unit DU so that data related to a portion that causes the sign of the abnormality is added (step S25).

In the transmission device 2, the operation data unit DU corresponding to the transmission request is transmitted to the collection device 3 and the management device 110 on the basis of the transmission request for the operation data unit DU from the collection device 3.

In the management device 110, the received operation data unit DU is stored in the storage device.

In the collection device 3, the process of the flowchart illustrated in FIG. 11 is executed on the basis of the received operation data unit DU.

The collection device 3 transmits the diagnosis results acquired in step S21 to the management device 110.

Thus, in the collection device 3, appropriate operation data unit DU for use in diagnosis in the diagnosis device 100 is collected.

As described above, according to the embodiment, first, the first inspection unit 341 inspects whether or not the operation data unit DU is authentic. Accordingly, in the embodiment, it is possible to guarantee that there is no data inconsistency due to a communication error or data falsification, with respect to the operation data unit DU. Furthermore, according to the embodiment, the second inspection unit 342 inspects the presence or absence of an abnormality in the data of the operation data unit DU. Accordingly, in the embodiment, it is possible to guarantee that there is no abnormality in the data of the operation data unit DU.

In the embodiment, when the data of the operation data unit DU is not authentic, the first transmission request unit 344 requests the transmission device 2 to retransmit the operation data unit DU. In the embodiment, when the data of the operation data unit DU is determined to be abnormal, the second transmission request unit 345 requests the transmission device 2 to transmit the operation data unit DU at times before and after the operation data unit DU of which the data is determined to be abnormal. Accordingly, in the embodiment, when the data of the received operation data unit DU is not authentic or when the data is determined to be abnormal, it is possible to collect the operation data unit DU from the transmission device 2.

Thus, in the embodiment, it is possible to appropriately collect the operation data units DU for use in the diagnosis in the diagnosis device 100. According to the embodiment, it is possible to cause the diagnosis device 100 to execute the diagnosis process on the basis of the appropriately collected operation data unit DU. Thus, in the embodiment, it is possible to improve the accuracy of the diagnosis in the diagnosis device 100.

In the embodiment, when it is determined that there is a sign of an abnormality on the basis of the diagnosis results of the diagnosis device 100, the third transmission request unit 346 can appropriately collect the operation data unit DU in which the sampling interval has been changed or the data item has been added. The diagnosis device 100 executes the diagnosis process on the basis of the operation data unit DU in which the sampling interval has been changed or the data item has been added. Accordingly, in the embodiment, it is possible to specify the cause of the sign of the abnormality accurately and promptly.

In the embodiment, only when it is determined that there is a sign of an abnormality, transmission of the operation data unit DU in which the sampling interval of the operation data unit DU has been changed or the data item has been added is requested. Thus, in the embodiment, it is possible to appropriately collect the operation data unit DU without unnecessarily increasing a data amount of the operation data unit DU.

Moreover, in the embodiment, since the data amount of the operation data unit DU is not unnecessarily increased, it is possible to suppress an increase in time required for information processing in the collection system 1 and the diagnosis device 100.

Although the collection device, the collection method, the program, and the collection system according to the embodiment have been described above, the present invention may be implemented in various different embodiments other than the embodiments described above.

Although the diagnosis device 100 has been described as a device different from the collection device 3, the diagnosis device 100 may be one device combined with the collection device 3.

### REFERENCE SIGNS LIST

1 Collection system
2 Transmission device
3 Collection device
31 Reception unit
32 Transmission unit
33 Storage unit
34 Control unit
341 First inspection unit
342 Second inspection unit
343 Acquisition unit
344 First transmission request unit
345 Second transmission request unit
346 Third transmission request unit
347 Fourth transmission request unit
348 Complementing unit
100 Diagnosis device
110 Management device
DU Operation data unit

1. A collection device comprising:
a reception unit that receives a data unit including operation data indicating an operation state of a plant and a guarantee value for guaranteeing authenticity of the operation data;
a first inspection unit that inspects the authenticity of the data unit by inspecting a quality of the data unit on the basis of the guarantee value and by inspecting the presence or absence of a loss of the data on the basis of a reception interval of the data unit; and
a first transmission request unit that requests a transmission side of the data unit to retransmit the data unit when inspection results of the first inspection unit indicate no authenticity.

2. The collection device according to claim 1, comprising:
a second inspection unit that inspects whether or not the operation data is normal on the basis of whether or not the operation data is a value in a predetermined range; and
a second transmission request unit that requests the transmission side of the data unit to transmit a predetermined data unit,
wherein the second transmission request unit requests the transmission side of the data unit to transmit a data unit at a time different from that of the data unit including the operation data determined to be abnormal when the second inspection unit determines that the operation data is abnormal.

3. The collection device according to claim 2, comprising a complementing unit that complements a value of the operation data included in the data unit,
wherein the second inspection unit determines whether or not a process of diagnosing a sign of an abnormality of the plant is executable on the basis of the data unit by complementing the value of the operation data determined to be abnormal with respect to the data unit including the operation data determined to be abnormal in the second inspection unit, and
when the second inspection unit determines that the diagnosis process is executable, the complementing unit complements the value of the operation data determined to be abnormal.

4. The collection device according to claim 1, comprising:
an acquisition unit that acquires diagnosis results of a process of diagnosing a sign of an abnormality of the plant using the data unit; and
a third transmission request unit that requests the transmission side of the data unit to transmit the data unit so that a reception interval in the reception unit is changed,
wherein when the diagnosis results acquired by the acquisition unit indicates that there is a sign of an abnormality, the third transmission request unit requests the transmission side of the data unit to transmit the data unit so that the reception interval in the reception unit is changed.

5. The collection device according to claim 1, comprising:
an acquisition unit that acquires diagnosis results of a process of diagnosing a sign of an abnormality of the plant using the data unit; and
a fourth transmission request unit that requests the transmission side of the data unit to change items of the operation data to be included and transmit the data unit,
wherein when the diagnosis results acquired by the acquisition unit indicates that there is a sign of an abnormality, the fourth transmission request unit requests the transmission side of the data unit to change the items of the operation data to be included and transmit the data unit.

6. The collection device according to claim 4,
wherein when the diagnosis results acquired by the acquisition unit indicates that there is a sign of an abnormality, the third transmission request unit requests the transmission side of the data unit to shorten the reception interval in the reception unit and transmit the data unit.

7. The collection device according to claim 4, wherein when the diagnosis results acquired by the acquisition unit indicates that there is a sign of an abnormality, the third transmission request unit requests the transmission side of the data unit to shift the reception interval in the reception unit and transmit the data unit.

8. A collection method comprising:
receiving a data unit including operation data indicating an operation state of a plant and a guarantee value for guaranteeing authenticity of the operation data;
inspecting the authenticity of the data unit by inspecting a quality of the data unit on the basis of the guarantee value and by inspecting the presence or absence of a loss of the data on the basis of a reception interval of the data unit; and
requesting a transmission side of the data unit to retransmit the data unit when inspection results of inspecting the authenticity of the data unit indicate no authenticity.

9. A non-transitory computer-readable storage medium on which an executable collection program is stored, the collection program causing a computer to execute:
receiving a data unit including operation data indicating an operation state of a plant and a guarantee value for guaranteeing authenticity of the operation data;
inspecting the authenticity of the data unit by inspecting a quality of the data unit on the basis of the guarantee value and by inspecting the presence or absence of a loss of the data on the basis of a reception interval of the data unit; and
requesting a transmission side of the data unit to retransmit the data unit when inspection results of inspecting the authenticity of the data unit indicate no authenticity.

10. A collection system comprising:
a collection device including
a reception unit that receives a data unit including operation data indicating an operation state of a plant and a guarantee value for guaranteeing authenticity of the operation data,
a first inspection unit that inspects the authenticity of the data unit by inspecting a quality of the data unit on the basis of the guarantee value and by inspecting the presence or absence of a loss of the data on the basis of a reception interval of the data unit, and
a first transmission request unit that requests a transmission side of the data unit to retransmit the data unit when inspection results of the first inspection unit indicate no authenticity; and
a transmission device including a transmission unit that transmits the data unit to the collection device.
